(19) United States
(12) Patent Application Publication
(10) Pub. No.: US 2026/0159629 A1
(43) Pub. Date: Jun. 11, 2026

(54) POLYOL CATALYST FOR A TWO-COMPONENT POLYURETHANE SYSTEM

(71) Applicant: Arkema France, Colombes (FR)

(72) Inventors: Sylvain BEAUDRAIS, Verneuil En Halatte (FR); Frank COGORDAN, Verneuil En Halatte (FR); Catherine GROBON, Verneuil En Halatte (FR); Benoit SATZ, Verneuil En Halatte (FR)

(21) Appl. No.: 18/723,896

(22) PCT Filed: Dec. 15, 2022
(86) PCT No.: PCT/EP2022/086208

§ 371 Date: Jun. 25, 2024

(30) Foreign Application Priority Data
Dec. 30, 2021 (FR) FR21.14682

(51) Int. Cl. C08G 18/18

(52) U.S. Cl. CPC C08G 18/1825; C08G 2150/00

(57) ABSTRACT

Polyol catalyst for a two-component polyurethane system

The present invention relates to a polyol catalyst for the production of polyurethanes comprising:
at least two alcohol functions,
at least one catalyst function chosen from imidazole and/or tertiary amine functions,
at least one urea function.

The present invention also relates to a process for preparing a catalyst according to the invention.

A crosslinkable two-component polyurethane composition comprising:
a) a polyisocyanate component,
b) a polyol component based on a polyol catalyst according to the invention, and optionally another polyol component free of a catalyst function chosen from imidazole and/or tertiary amine functions, is also part of the invention.

Lastly, the invention relates to a coating composition based on a crosslinkable two-component polyurethane composition according to the invention, a process for preparing such a coating, and a substrate coated with a crosslinkable two-component polyurethane composition according to the invention.

### TECHNICAL FIELD

The present invention relates to the field of two-component polyurethane coatings based on organic solvents or in aqueous dispersion.

More particularly, the invention relates to a polyol catalyst for the formation of two-component polyurethane coatings, a process for preparing such a catalyst, the use thereof as catalyst or as polyol component in a crosslinkable two-component polyurethane composition, a crosslinkable two-component polyurethane composition and the final applications thereof.

### PRIOR ART

Polyurethanes are one of the largest classes of polymer materials. They are generally prepared by bringing two products into contact: a polyol (binder resin) and a polyisocyanate (crosslinking agent). The room temperature reaction between these two products is slow and requires the addition of a catalyst, usually a tin-based metallic catalyst, in order to form the two-component polyurethane coating.

Polyurethane coatings are known for their very good performance in terms of chemical resistance, heat resistance, and water resistance, and are widely used in the field of industrial paints. By appropriately choosing the polyol component, the polyisocyanate component and the catalyst, it is even possible to confer particular properties on the polyurethane coating, depending on the desired final performance, for example in terms of flexibility or transparency.

However, the use of metallic catalysts, in particular tin-based catalysts, during the reaction between the polyol and the polyisocyanate poses problems of toxicity, safety and harmfulness to human health and to the environment in general. The elimination of these catalysts is often extremely difficult and very expensive, which is a major drawback for most of the applications in question.

In addition, polyurethanes in aqueous dispersion have been developed in favor of polyurethanes based on organic solvents in order to reduce the emissions of volatile organic compounds (VOCs) into the atmosphere. However, in an aqueous medium, tin-based catalysts lead to side reactions between the isocyanate functions and water, requiring the use of a larger amount of catalyst, and thus reducing the original advantage of aqueous polyurethanes.

Thus, over the past decade, ecological approaches have been developed for the synthesis of more sustainable polyurethanes.

EP 1 022 298 B1 describes catalysts for the manufacture of polyurethanes obtained by reaction between (a) polymer compounds containing carboxylic acid and/or anhydride groups with (b) compounds having at least one primary or secondary amino group and/or with compounds having a tertiary amino group and at least one group that reacts with acid or anhydride groups. This reaction is not complete, the compounds having at least one unreacted free amino group leading to a strong odor. Another drawback of the polymer compounds used during this reaction is their molar mass, and therefore their viscosity, which is very high, requiring the use of large amounts of diluent.

EP 0 046 088 B1 describes the use of polyoxyalkylene polyamines as curing agents for the polyurethane formation by reacting polyoxyalkylene polyamines with derivatives of acrylic acid or alpha-substituted acrylic acids having terminal hydroxy groups, optionally in the presence of a compound having an oxirane ring. However, the polyisocyanates used are mainly aromatic, and the catalytic functions proposed are not very reactive with aliphatic isocyanates.

The use of tertiary amines as catalysts for the manufacture of polyurethanes has also been studied, but their migration within the coating film remains, which adversely affects the final performance of the coating (H. Sardon et al., Macromolecules 2015, 48, 3153-3165).

In view of their toxicity, the metallic catalysts used during the preparation of polyurethanes need to be replaced by catalysts that are less toxic to humans and the environment, which are capable of reducing the time taken to form a coating film, and that do not migrate within the coating over time.

The technical problem to be solved by the present invention thus consists in developing a catalyst for the reaction between a polyol and a polyisocyanate which is environmentally friendly and does not use any toxic compounds, while having a mechanical performance and a working time (ease of use) that are improved or at least comparable to those of tin-based catalysts.

The invention therefore aims to provide an environmentally friendly catalyst for the reaction between a polyol and a polyisocyanate, which is free of toxic compounds, and which also has improved mechanical performance, in particular in terms of hardness and chemical resistance, linked to the presence of urea functions, compared to conventional tin-based catalysts. The catalyst of the invention also makes it possible to prepare polyurethanes both in solvent-based and aqueous media, and more particularly in an aqueous medium in order to reduce VOC emissions into the atmosphere.

The catalyst of the invention also has the advantage of being covalently grafted to the polyurethane, and thus of being incorporated into the very structure of the polyurethane, thus preventing any migration out of the polyurethane over time. This advantageously makes it possible to reduce the odor and VOC emissions associated with the use of conventional tertiary amines.

Lastly, the catalyst of the invention has a low polydispersity and a low viscosity, which makes the coating composition into which it is incorporated easy and quick to apply, without any additional supply of heat (low-energy process).

### DISCLOSURE OF THE INVENTION

One subject of the invention is a compound comprising alcohol functions and at least one function chosen from imidazole and/or tertiary amine functions. Since the imidazole and tertiary amine functions are capable of catalyzing the urethanization reaction between an alcohol function and an isocyanate function, they can be denoted by the term “catalyst function”. The compound according to the invention therefore comprises alcohol functions and at least one catalyst function and will therefore be denoted hereinafter by the term “polyol catalyst”.

The polyol catalyst of the invention comprises:
at least two alcohol functions, and preferably two alcohol functions,
at least one catalyst function chosen from imidazole and/or tertiary amine functions, and preferably at least two catalyst functions chosen from imidazole and/or tertiary amine functions,
at least one urea function, and preferably at least two urea functions.

The polyol catalyst may in particular be capable of catalyzing the urethanization reaction between an alcohol function and an isocyanate function, in particular the polyol catalyst is capable of producing polyurethanes.

The polyol catalyst comprises at least one catalyst function. Preferably, the polyol catalyst comprises at least two identical or different catalyst functions. Within the meaning of the present invention, a catalyst function is a function capable of catalyzing the urethanization reaction between an alcohol function and an isocyanate function.

The at least one catalyst function is chosen from imidazole and/or tertiary amine functions.

The tertiary amine function may in particular have a pKa≥9, preferably a pKa≥10. The tertiary amine function advantageously corresponds to the formula
—NR₁R₂ wherein R₁ and R₂, which may be identical or different, represent a C1-C4 alkyl or a cycloalkyl or else R₁ and R₂, together with the nitrogen atom to which they are attached, form a C2-C6 heterocycle.

The imidazole function may correspond in particular to the following formula:

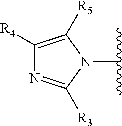

wherein R₃, R₄ and R₅ are independently selected from H, alkyl, aryl and alkylaryl or else R₄ and R₅, together with the carbon atoms to which they are bonded, may form a ring.

For the purposes of the present invention, the following definitions apply:
Alkyl: a saturated, linear or branched aliphatic hydrocarbon-based group. A C₁-C₄ alkyl means an alkyl having from 1 to 4 carbon atoms. The term “branched” means that at least one alkyl group such as methyl or ethyl is borne by a linear alkyl chain. As alkyl groups, mention may for example be made of methyl, ethyl, n-propyl, isopropyl, n-butyl, t-butyl and n-pentyl groups;
Cycloalkyl: a saturated hydrocarbon-based ring optionally substituted with one or more alkyl groups. Examples of cycloalkyls are cyclopropyl, cyclobutyl, cyclopentyl, cyclohexyl or isobornyl;
Heterocycle: a (preferably non-aromatic) ring in which at least one ring atom is a heteroatom, preferably chosen from O, N or S, more preferentially N or O. A C2-C6 heterocycle denotes a heterocycle having from 2 to 6 carbon atoms. A heterocycle may optionally be substituted with one or more alkyl groups or else two ring atoms may be connected by an alkylene bridge to form a polycyclic heterocycle. Examples of heterocycles are morpholine, piperidine, pyrrolidine or quinuclidine;
Aryl: an aromatic group. An aryl may contain a single ring or several rings, at least one of which is aromatic. Examples of aryls are phenyl, naphthyl or biphenyl;
Alkylaryl: an alkyl group as defined above substituted with an aryl group. An example of alkylaryl is benzyl.

The polyol catalyst comprises at least one urea function. Preferably, the polyol catalyst comprises at least two urea functions.

A urea function may in particular be a substituted urea function. Within the meaning of the invention, a substituted urea function is a urea function having at least one nitrogen atom which does not bear a hydrogen atom. Preferably, a substituted urea function may correspond to the formula *—NR₆—C(═O)—NH—* wherein R₆ is a substituent other than H, and the * symbols each represent a point of attachment to a carbon atom.

A substituted urea function may in particular have a substituent R₆ originating from an aza-Michael reaction between a primary amine and a compound functionalized with at least one (meth)acrylate group, preferably a compound functionalized with at least one acrylate group, more preferentially a compound functionalized with a single acrylate group. In particular, R₆ may comprise a unit of formula #—CH₂—CH₂—C(═O)—O—§ wherein # represents a point of attachment to the nitrogen atom of the substituted urea function and § represents a point of attachment to a carbon atom.

A substituted urea function may in particular have a substituent Z carrying at least one catalyst function as defined above (i.e. an imidazole or tertiary amine function). In particular, Z may be a group of formula —A′—(CAT)ₚ wherein:
A′ is an alkylene or an alkylene comprising at least one heteroatom, preferably a C2-C6 alkylene,
p is 1 or 2, and preferably 1;
CAT is a catalyst function as defined above (i.e. an imidazole or tertiary amine function).

For the purposes of the present invention, the following definitions apply:
Alkylene: an aliphatic radical derived from an alkane of formula CₘH₂ₘ₊₂ with m=1 to 50, by removing a hydrogen atom at each point of attachment of the radical. An alkylene may be linear or branched. An alkylene may be divalent, trivalent, tetravalent, pentavalent or hexavalent. A C2-C6 alkylene means an alkylene having from 2 to 6 carbon atoms.
Alkylene comprising at least one heteroatom: an alkylene in which at least one carbon atom is replaced by a heteroatom, in particular chosen from O, N or S, preferably N.

According to an advantageous embodiment, a substituted urea function corresponds to the (or is included in a group of) formula ZZ—NR₆—C(═O)—NH—* wherein R₆ and Z are as defined above and the * symbol represents a point of attachment to a carbon atom.

According to a preferred embodiment, the polyol catalyst of the invention corresponds to the following formula (1):

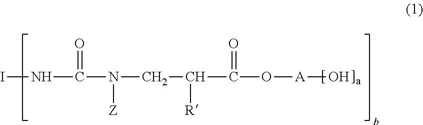

wherein:
   I is the residue of a polyisocyanate,
   R′ is H or methyl, preferably H,
   Z is a group comprising at least one catalyst function as defined above,
   A is the residue of a polyol, and preferably A is a C2-C12 alkylene which is optionally alkoxylated or esterified, for example with an ester function originating from the opening of a lactone such as caprolactone,
   a=1 to 5, and preferably a=1, and
   b=2 to 3, and preferably b=2.

In formula (1) of the polyol catalyst of the invention, I is advantageously the residue of a diisocyanate.

In formula (1) of the polyol catalyst of the invention, Z is advantageously a group of formula —A′—(CAT)ₚ as defined above.

In formula (1) of the polyol catalyst of the invention, Z is advantageously the residue of a polyol chosen from: ethylene glycol, 1,2- or 1,3-propylene glycol, 1,2-, 1,3- or 1,4-butylene glycol, 1,5-pentanediol, 1,6-hexanediol, 1,8-octanediol, 1,9-nonanediol, 1,10-decanediol, 1,12-dodecanediol, 2-methyl-1,3-propanediol, 2,2-diethyl-1,3-propanediol, 3-methyl-1,5-pentanediol, 3,3-dimethyl-1,5-pentanediol, neopentyl glycol, 2,4-diethyl-1,5-pentanediol, cyclohexanediol, cyclohexane-1,4-dimethanol, norbornenedimethanol, norbornanedimethanol, tricyclodecanediol, tricyclodecanedimethanol, bisphenol A, B, F or S, hydrogenated bisphenol A, B, F or S, trimethylolmethane, trimethylolethane, trimethylolpropane, di(trimethylolpropane), triethylolpropane, pentaerythritol, dipentaerythritol, glycerol, di-, tri- or tetraglycerol, di-, tri- or tetraethylene glycol, di-, tri- or tetrapropylene glycol, di-, tri- or tetrabutylene glycol, a polyethylene glycol preferably having a weight-average molecular weight M_{w} ranging from 200 to 10 000 g·mol⁻¹, a polypropylene glycol preferably having a weight-average molecular weight M_{w} ranging from 200 to 10 000 g·mol⁻¹, a polytetramethylene glycol preferably having a weight-average molecular weight M_{w} ranging from 200 to 10 000 g·mol⁻¹, a poly(ethylene glycol-co-propylene glycol) preferably having a weight-average molecular weight M_{w} ranging from 200 to 10 000 g·mol⁻¹, an alditol (i.e. erythritol, threitol, arabitol, xylitol, ribitol, mannitol, sorbitol, galactitol, fucitol or iditol), a dianhydrohexitol (i.e. isosorbide, isomannide or isoidide), tris(2-hydroxyethyl) isocyanurate, a polybutadiene polyol preferably having a weight-average molecular weight M_{w} ranging from 200 to 10 000 g·mol⁻¹, a polyester polyol preferably having a weight-average molecular weight M_{w} ranging from 200 to 10 000 g·mol⁻¹, a polyether polyol preferably having a weight-average molecular weight M_{w} ranging from 200 to 10 000 g·mol⁻¹, a polyorganosiloxane polyol preferably having a weight-average molecular weight M_{w} ranging from 200 to 10 000 g·mol⁻¹, a polycarbonate polyol preferably having a weight-average molecular weight M_{w} ranging from 200 to 10 000 g·mol⁻¹, and also the alkoxylated (e.g. ethoxylated and/or propoxylated) derivatives thereof, and the derivatives obtained by ring-opening polymerization of a lactone (e.g. ε-caprolactone) initiated with one of the abovementioned polyols.

In formula (1) of the polyol catalyst of the invention, a is advantageously equal to 1.

In formula (1) of the polyol catalyst of the invention, b is advantageously equal to 2.

The second subject of the invention relates to a process for preparing a catalyst according to the invention comprising the following steps:
(i) Michael reaction between a hydroxylated (meth)acrylate monomer and a monomer having at least one primary amine function and at least one catalyst function as defined above, and
(ii) reaction between the amino-ester compound obtained on conclusion of step (i) with a polyisocyanate, in order to form a polyol catalyst with at least one urea function.

Within the meaning of the invention, a hydroxylated (meth)acrylate monomer is a compound functionalized with at least one (meth)acrylate group (i.e. a group of formula —O—C(═O)—CHR′═CH₂ in which R′ is hydrogen or methyl) and at least one hydroxyl (—OH) group. A hydroxylated (meth)acrylate monomer may in particular be functionalized with at least one acrylate group (R′═H), preferably functionalized with a single acrylate group. A hydroxylated (meth)acrylate monomer may in particular be functionalized with at least one hydroxyl group, preferably functionalized with 1, 2, 3, 4 or 5 hydroxyl groups, more preferentially functionalized with a single hydroxyl group. More preferentially, a hydroxylated (meth)acrylate monomer is a compound functionalized with a single acrylate group and a single hydroxyl group.

The hydroxylated (meth)acrylate monomer used in step (i) of the process according to the invention may in particular correspond to the following formula (2)

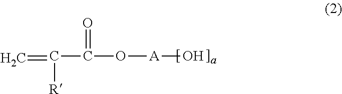

wherein:
   R′ is H or methyl, preferably H,
   A is the residue of a polyol, and preferably A is a C2-C12 alkylene which is optionally alkoxylated or esterified, for example with an ester function originating from the opening of a lactone such as caprolactone,
   a=1 to 5, and preferably a=1.

The hydroxylated (meth)acrylate monomer of formula (2) may in particular result from the reaction of a polyol of formula (3) with a (meth)acrylating agent such as (meth)acrylic acid, (meth)acrylic anhydride or (meth)acryloyl chloride:

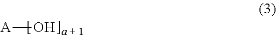

wherein
   A is the residue of a polyol, and preferably A is a C2-C12 alkylene which is optionally alkoxylated or esterified, for example with an ester function originating from the opening of a lactone such as caprolactone,
a=1 to 5, and preferably a=1.

According to a preferred embodiment, the hydroxylated (meth)acrylate monomer used during step (i) is chosen from 2-hydroxyethyl acrylate, 2-hydroxypropyl acrylate, 3-hydroxypropyl acrylate, 2-hydroxybutyl acrylate, 3-hydroxybutyl acrylate, 4-hydroxybutyl acrylate, 2-hydroxy-3-phenoxypropyl acrylate, 3-chloro-2-hydroxypropyl acrylate, glycerol monoacrylate, trimethylolpropane monoacrylate, di(trimethylolpropane) monoacrylate, trimethylolethane monoacrylate, pentaerythritol monoacrylate, dipentaerythritol monoacrylate, polyethylene glycol monoacrylate, polypropylene glycol monoacrylate, polyethylene-co-polypropylene glycol monoacrylate, polytetramethylene glycol monoacrylate, a polycaprolactone (meth)acrylate corresponding to the following formula (4):

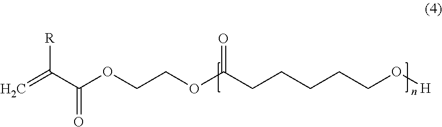

wherein R represents H or methyl, and n=1 to 10,
or mixtures thereof.

According to an even more preferred embodiment, the hydroxylated (meth)acrylate monomer used during step (i) is chosen from hydroxyethyl acrylate, hydroxyethyl methacrylate, hydroxypropyl acrylate, a polycaprolactone (meth)acrylate corresponding to formula (2) above, or mixtures thereof.

The monomer having at least one primary amine function used in step (i) of the process according to the invention may in particular correspond to the following formula (5):

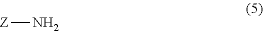

wherein Z is a group comprising at least one catalyst function as defined above (i.e. an imidazole or tertiary amine function).

The monomer having at least one primary amine function and at least one catalyst function used during step (i) may also optionally comprise at least one secondary amine function.

According to a preferred embodiment, the monomer having at least one primary amine function and at least one catalyst function used during step (i) is chosen from N,N-dimethylethylenediamine, N,N-diethylethylenediamine, dimethylaminopropylamine (DMAPA), 3-(diethylamino)-1-propylamine (DEAPA), 4-(dimethylamino)-1-butylamine, 4-(diethylamino)-1-butylamine, 5-(dimethylamino)-1-pentylamine, N,N-dimethyldipropylenetriamine (DMAPAPA), N-(2-aminoethyl)-N-methylcyclohexanamine, 2-morpholinoethylamine, 3-morpholinopropylamine, 2-piperidinoethylamine, 3-piperidinopropylamine, 5-piperidinopentylamine, 2-(4-methyl-1-piperidinyl) ethanamine, 2-pyrrolidinoethylamine, 3-pyrrolidinopropylamine, 2-(2-aminoethyl)-1-methylpyrrolidine, 2-(4-methyl-piperazin-1-yl)-ethylamine, 1-(3-aminopropyl) imidazole, 1-(3-aminopropyl)-2-methyl-1H-imidazole, 1-(4-aminobutyl) imidazole, or mixtures thereof.

According to an even more preferred embodiment, the monomer having at least one primary amine function and at least one catalyst function used during step (i) is chosen from dimethylaminopropylamine (DMAPA), 3-(diethylamino)-1-propylamine (DEAPA), N,N-dimethyldipropylenetriamine (DMAPAPA), 1-(3-aminopropyl) imidazole, or mixtures thereof.

The amino-ester compound obtained on conclusion of step (i) may in particular correspond to the following formula (6):

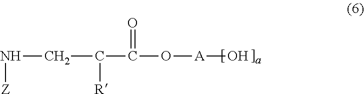

wherein
   R′ is H or methyl, preferably H,
   A is the residue of a polyol, and preferably A is a C2-C12 alkylene which is optionally alkoxylated or esterified, for example with an ester function originating from the opening of a lactone such as caprolactone,
   Z is a group comprising at least one catalyst function as defined above (i.e. an imidazole or tertiary amine function),
   a=1 to 5, and preferably a=1.

The polyisocyanate used in step (ii) of the process according to the invention may in particular correspond to the following formula (7):

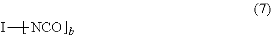

wherein
   I is the residue of a polyisocyanate,
   b=2 to 3, and preferably b=2.

According to a preferred embodiment, the polyisocyanate used during step (ii) is chosen from isophorone diisocyanate (IPDI), toluene diisocyanate (TDI), diphenylmethane-4,4′-diisocyanate (4,4′-MDI), dicyclohexylmethane-4,4′-diisocyanate, tetramethylxylene diisocyanate (TMXDI), hydrogenated tetramethylxylene diisocyanate, hexamethylene diisocyanate (HDI), norborane diisocyanate (NBDI), trimethylenehexamethylene diisocyanate, 1,5-naphthylene diisocyanate, biuret, allophanate and isocyanurate forms of these polyisocyanates, or mixtures thereof.

According to an even more preferred embodiment, the polyisocyanate used during step (ii) is chosen from isophorone diisocyanate (IPDI), toluene diisocyanate (TDI), hexamethylene diisocyanate (HDI), or mixtures thereof.

In a preferred embodiment, the molar ratio between the primary amine functions of step (i) and the isocyanate functions varies from 0.8 to 1.2, and preferably is around 1, this being in order to obtain a polyol catalyst which is not very polydisperse and consequently which is not very viscous.

The process of the invention may also comprise an intermediate step between steps (i) and (ii) aimed at consuming residual primary amines still present which might not have reacted during step (i). This intermediate step may consist of the addition of a (meth)acrylate monomer, it being possible for the latter to be identical to or different from the hydroxylated (meth)acrylate monomer used during step (i). The (meth)acrylate monomer added during this intermediate step is preferably a monofunctional or multifunctional (meth)acrylate monomer such as 1.6-hexanediol diacrylate (HDDA), tert-butylcyclohexyl acrylate, 2-(2-ethoxyethoxy)ethyl acrylate, lauryl acrylate, isobornyl acrylate, 3-methyl-1,5-pentanediol diacrylate, 1,10-decanediol diacrylate, tricyclodecanedimethanol diacrylate, di(trimethylolpropane) tetraacrylate.

The process of the invention may also comprise the addition of a monomer having at least one primary amine function and at least one alcohol function, such as ethanolamine or a (poly)alkylene glycol hydroxylamine of formula NH₂-[Alk-O]_{q}-Alk-OH in which each Alk is a C2-C4 alkylene (in particular ethylene, propylene or tetramethylene) and q ranges from 1 to 30 (in particular from 1 to 10). The addition of such a monomer can in particular increase the number of alcohol functions of the polyol catalyst, and thus the crosslinking density of the polyurethane system. Preferably, the monomer having at least one primary amine function and at least one alcohol function is added during step (i), and more preferentially at the same time as the monomer having a primary amine function and a catalyst function. In this embodiment, the weight ratio between the monomer having at least one primary amine function and at least one catalyst function and the monomer having at least one primary amine function and at least one alcohol function varies from 0.1% to 100%, and preferably between 30% and 70%.

A third subject of the present invention relates to the use of a polyol catalyst according to the invention:
either as catalyst in a crosslinkable two-component polyurethane composition comprising a polyisocyanate component and a polyol component,
or as polyol component in a crosslinkable two-component polyurethane composition comprising, in addition, a polyisocyanate component and, optionally, another polyol component free of a catalyst function (i.e. free of an imidazole and/or tertiary amine function).

When the polyol catalyst of the invention is used as catalyst in a crosslinkable two-component polyurethane composition comprising a polyisocyanate component and a polyol component, it is preferably used in an amount ranging from 10% to 100% by weight relative to the total weight of the polyol component.

When the polyol catalyst of the invention is used as polyol component in a crosslinkable two-component polyurethane composition comprising, in addition, a polyisocyanate component and, optionally, another polyol component free of a catalyst function, it is preferably used in an amount ranging from 0.1% to 10% by weight relative to the total weight of the polyol component.

Thus, the fourth subject of the invention relates to a crosslinkable two-component polyurethane composition comprising:
a) a polyisocyanate component,
b) a polyol component comprising:
b1) from 0.1% to 100% by weight, relative to the total weight of the polyol component, of a polyol catalyst according to the invention, and
b2) from 0 to 99.9% by weight, relative to the total weight of the polyol component, of another polyol component free of a catalyst function (i.e. free of an imidazole and/or tertiary amine function).

The polyisocyanate component a) preferably has a functionality of greater than or equal to 3, more preferentially greater than 2 and even more preferentially equal to 3.

The polyol component b) preferably has an I_{OH} value of between 200 and 300 mg KOH/g, more preferentially between 50 and 200 mg KOH/g, and even more preferentially between 80 and 150 mg KOH/g.

In a first preferred embodiment, the polyol component of the crosslinkable two-component polyurethane composition of the invention may comprise:
b1) from 0.1% to 10% by weight, and preferably between 1% and 7% by weight, relative to the total weight of the polyol component, of a polyol catalyst according to the invention, and
b2) from 90% to 99.9% by weight, and preferably between 93% and 99% by weight, relative to the total weight of the polyol component, of another polyol component free of a catalyst function (i.e. free of an imidazole and/or tertiary amine function).

In a second preferred embodiment, the polyol component of the crosslinkable two-component polyurethane composition of the invention may comprise:
b1) from 10% to 100% by weight, relative to the total weight of the polyol component, of a polyol catalyst according to the invention, and
b2) from 0 to 90% by weight, relative to the total weight of the polyol component, of another polyol component free of a catalyst function (i.e. free of an imidazole and/or tertiary amine function).

According to a particularly preferred embodiment of the invention, the crosslinkable two-component polyurethane composition of the invention is free of metal catalyst, and in particular is free of tin-based catalyst.

The crosslinkable two-component polyurethane composition of the invention is advantageously a coating composition, and more particularly an aqueous coating composition, preferably chosen from paint, varnish, ink, adhesive and glue compositions, and more preferentially an aqueous paint or varnish composition. In particular, the crosslinkable two-component polyurethane composition of the invention may be a protective coating composition, in particular a finishing coating composition or an anti-corrosion coating composition, or a decorative coating composition. These coating compositions are particularly suitable for applications in the following fields: railroad renovation and construction, motor vehicles, road transport, naval, aeronautics, agricultural machinery, public works machinery, wind turbines, oil platforms, containers, metal structures, metal reinforcements or coils, or buildings including furniture, wooden flooring, carpentry and frameworks.

Another subject of the invention relates to a process for preparing a coating, comprising a step of applying a crosslinkable two-component polyurethane composition according to the invention on a substrate, followed by a step of drying said composition, preferably at room temperature (20° C.). The crosslinkable two-component polyurethane composition according to the invention may be applied by means of a brush, a roller or by means of a spray or else by dip coating.

The crosslinkable two-component polyurethane composition of the invention is preferably applied on a substrate chosen from metal, glass, wood, including chipboard and plywood, plastic, metal, concrete, plaster, composite and textile substrates.

Finally, the last subject of the invention relates to a substrate coated with a crosslinkable two-component polyurethane composition according to the invention, preferably chosen from metal, glass, wood, including chipboard and plywood, plastic, metal, concrete, plaster, composite and textile substrates.

In addition to the above provisions, the invention also comprises other provisions which will emerge from the remainder of the description which follows, which relates to examples for the preparation of polyol catalysts according to the invention, and to the evaluation of crosslinkable two-component polyurethane compositions comprising same, and to FIG. 1 and to FIG. 2.

### BRIEF DESCRIPTION OF THE FIGURES

FIG. 1 is a graph showing the gloss retention at an angle of 20° over time for various reference two-component polyurethane systems and two-component polyurethane systems according to the invention.

FIG. 2 is a graph representing the showing the coloration (ΔE* ab) over time for various reference two-component polyurethane systems and two-component polyurethane systems according to the invention.

### EXAMPLES

### Methods for Measuring and Evaluating Application Performance:

In the present application, the following methods for measuring and evaluating application performance were used:

### Amine Value:

The amine value was measured by assaying with a Metrohm (848 Titrino Plus) titrimeter equipped with a Metrohm reference 6.0262.100 measurement probe. The sample to be analyzed was weighed in a 100 ml beaker. 50 ml of dichloromethane were added. The sample was completely dissolved by magnetic stirring. The titration was carried out under magnetic stirring with 0.1 N perchloric acid in acetic acid, according to the method of use of the chosen titrimeter. The amine value was calculated according to the following equation:

$${I}_{Amine} ( mg KOH / g ) = \frac{V E \times N T \times 56.1}{M}$$

wherein:
VE=Volume of titrant added for assaying the sample (ml),
NT=Normality of the titrant (0.1 N), and
M=Mass of the sample (g).

### Pot Life:

The pot life is the time needed to observe a doubling of the initial viscosity of a varnish composition. The viscosity is measured at regular intervals over time. The set of measurements makes it possible to plot a straight line which makes it possible to calculate the “pot-life” of the composition by linear regression. This standard measurement makes it possible to know the ideal range of use of the composition without losing application properties.

### Dust-Free Drying Time:

The dust-free drying time is measured according to the standard NF EN ISO 9117-3 of 2010. Using a film applicator, a varnish composition with a thickness of around 40-50 μm (dry thickness) is applied on a QD412 steel panel (in an air-conditioned room at 23° C. and 50% relative humidity). The film is then brought into contact with calibrated micron-size glass beads (particle size 125/250 μm). After a contact time of 10 seconds, the plate is tilted and then de-dusted using a brush at various times, until the beads completely detach from the surface of the varnish. The time when the balls no longer stick to the surface corresponds to dust-free drying time.

### Persoz Hardness:

The Persoz hardness is measured according to the standard NF EN ISO 1522 of March 2007. The Persoz hardness is measured after application with a film applicator of a varnish composition with a thickness of around 40-50 μm (dry thickness) on a QD46 steel panel (in an air-conditioned room at 23° C. and 50% relative humidity). The measurement is a damping time in seconds of the pendulum between 12° and 4°. The balls of the pendulum are placed on the panel coated with the varnish. The damping time is recorded on the automatic counter. The measurements are made at regular intervals over time in order to follow the development of hardness.

### Chemical Resistance:

The chemical resistance is evaluated after application with a film applicator of a varnish composition with a thickness of around 40-50 μm (dry thickness) on an QD46 steel panel (in an air-conditioned room at 23° C. and 50% relative humidity). The chemical resistance is measured using a Taber® 5750 linear abrasion tester after drying of the film for 7 days in an air-conditioned room at 23° C. and 50% relative humidity. The methyl ethyl ketone (MEK) resistance of the varnish film is evaluated by the time required (in seconds) for the wear of the varnish surface with a one kilogram weight equipped with a cotton pad soaked in MEK performing back-and-forth movements on the coating to be tested, until the varnish is completely destroyed. The speed of the sliding shaft is fixed. The cotton is moistened regularly.

### Adhesion:

The adhesion is measured according to the standard NF EN ISO 2409 of 2013, after application with a film applicator of a varnish composition with a thickness of around 40-50 μm (dry thickness) on an QD46 steel panel (in an air-conditioned room at 23° C. and 50% relative humidity). The adhesion test evaluates the resistance of the coating to being separated from the substrate on which it is applied, by making a grid pattern by incisions in the coating down to the substrate. A standardized adhesive tape (Scotch® 2525-7.5 N/cm from 3M) is affixed and rubbed firmly on the grid pattern and then torn off at an angle of 60°. Visual observation of the notched zone makes it possible to evaluate the amount of coating remaining on the support. The scoring is carried out using the table from the standard, on a scale of 0 (good) to 5 (poor). The adhesion performance is monitored over time after 1, 7 and 14 days.

### Accelerated UV Aging (According to the Standard NF EN 927-6 of 2006):

The apparatus used is equipped with 313 nm UVB lamps (harsh exposure to short wavelengths). The samples are exposed in a UV aging chamber (QUV Solar Eye-Labomat). Periods of exposure to light alternate with periods of condensation: 4 h with UV at 60° C., then 4 h of condensation at 50° C. The accelerated UV aging test makes it possible to reveal defects such as yellowing, bleaching, gloss loss (gloss retention), cracks, delamination, chalking, etc., faster than outdoor exposure. The test is carried out on an aluminum plate. As primer/varnish system: a layer of epoxy primer having a dry thickness of 50 μm is applied to an aluminum plate, then a layer of varnish to be tested having a dry thickness of 60 μm is applied, with an application time between the layers of 24 hours. In a DTM (Direct to Metal) varnish or paint system, a layer of varnish or paint to be tested having a dry thickness of 60 μm is applied directly to an aluminum plate. The coated aluminum plate is then stored for 2 days in an air-conditioned room (at 23° C. and 50% relative humidity), then for 2 days in an oven at 50° C., and finally for a minimum of 2 days in an air-conditioned room (at 23° C. and 50% relative humidity). The plate is then placed in the UV aging chamber. The gloss (then calculation of the gloss retention) and the color change ΔE* ab are monitored over time.

### Color Change ΔE* Ab:

The color change is measured using a Minolta CM2600d spectrocolorimeter (illuminant D65—daylight at 10°).

In the L a* b* color space, a color is defined from 3 coordinates:
L*: represents the value on a white-black axis,
a*: represents the value on a green-red axis,
b*: represents the value on a blue-yellow axis.

The color change ΔE* ab in the L a* b* color space is defined according to the following equation:

$$Δ {E}^{*} ab = √ {( Δ {L}^{*} )}^{2} + {( Δ {a}^{*} )}^{2} + {( Δ {b}^{*} )}^{2}$$

where ΔL*, Δa*, Δb* are the values of the color changes between the sample and the reference color.

### 20° Gloss:

The measurement of gloss at 20° is carried out according to the standard NF EN ISO 2813 (2014) (in an air-conditioned room at 23° C. and 50% relative humidity). The gloss test makes it possible to evaluate the reflective properties of the surface of a coating film by reflection of a light beam directed at a certain angle. The gloss is measured using a reflectometer on samples prepared according to the accelerated UV aging test described above. An average gloss retention is calculated on the basis of the arithmetic mean of the three measurements of residual gloss (after aging) relative to the initial gloss (before aging).

### Raw Materials:

The raw materials used for preparing the polyol catalysts according to the invention were the following:
dimethylaminopropylamine (DMAPA) from Sigma-Aldrich,
tert-octylamine from Sigma-Aldrich,
hexanediol diacrylate (HDDA) from Sartomer (trade name: SR238),
butyl acetate (BA) from Sigma-Aldrich,
hexamethylene diisocyanate (HDI) from Sigma-Aldrich,
Isophorone diisocyanate (IPDI) from Covestro (trade name: Desmodur® I), and
2-hydroxyethyl acrylate (2-HEA) from Sigma-Aldrich.

Example 1: Preparation of a polyol catalyst according to the invention tert-Octylamine (57.92 g, i.e. 0.4455 mol) was introduced at 23° C. into a reactor equipped with a reflux column, a dropping funnel, a thermometer and an inclined blade stirrer. 2-Hydroxyethyl acrylate (2-HEA) (74.21 g, i.e. 0.6397 mol) was then introduced via the dropping funnel over a period of 15 minutes. During the introduction of the 2-HEA, the temperature was maintained below 40° C. by controlling the exothermicity with an ice-water bath. After introduction of the 2-HEA, the temperature was maintained at 40° C. for 2 hours 30 minutes. Dimethylaminopropylamine (DMAPA) (19.63 g, i.e. 0.1925 mol) and butyl acetate (51.46 g) were then introduced into the dropping funnel and mixed therein. The mixture was then introduced into the reactor via the dropping funnel over a period of 20 seconds, then the temperature was brought to, then maintained at, 60° C. for 30 minutes. The mixture obtained was then cooled to 30° C. Hexamethylene diisocyanate (HDI) (53.88 g, i.e. 0.3207 mol) was then added dropwise via the dropping funnel over a period of 1 hour. During the introduction of the HDI, the temperature was maintained below 50° C. by controlling the exothermicity with an ice-water bath. After introduction of the HDI, the temperature was brought to, then maintained at, 80° C. for 1 hour. The amine value was then measured at 84 mg KOH/g. Infrared (IR) analysis showed the total consumption of the isocyanate functions initially present.

Example 2: Preparation of a polyol catalyst according to the invention Dimethylaminopropylamine (DMAPA) (51.00 g, i.e. 0.5000 mol) was introduced at 23° C. into a reactor equipped with a reflux column, a dropping funnel, a thermometer and an inclined blade stirrer. 2-HEA (62.00 g, i.e. 0.5345 mol) was then introduced dropwise via the dropping funnel over a period of 1 hour 30 minutes. During the introduction of the 2-HEA, the temperature was maintained below 50° C. by controlling the exothermicity with an ice-water bath. After introduction of the 2-HEA, the temperature was maintained at 50° C. for 30 minutes. Hexanediol diacrylate (HDDA) (7.50 g, i.e. 0.0332 mol) was then introduced via the dropping funnel over a period of 10 minutes, then the temperature was brought to, then maintained at, 75° C. for 30 minutes. Proton NMR analysis shows that all the 2-HEA, all the HDDA and all the DMAPA were consumed.

Butyl acetate (16.94 g) was then added via the dropping funnel (over 5 minutes), then the temperature was lowered to 30° C. HDI (31.92 g, i.e. 0.1900 mol) was then added dropwise via the dropping funnel over a period of 1 hour. During the introduction of the HDI, the temperature was maintained below 50° C. by controlling the exothermicity with an ice-water bath. After introduction of the HDI, the temperature was brought to, then maintained at, 80° C. for 1 hour. The amine value was then measured at 202 mg KOH/g. Infrared (IR) analysis showed the total consumption of the isocyanate functions initially present.

Example 3: Preparation of a polyol catalyst according to the invention DMAPA (51.00 g, i.e. 0.5000 mol) was introduced at 23° C. into a reactor equipped with a reflux column, a dropping funnel, a thermometer and an inclined blade stirrer. 2-HEA (62.00 g, i.e. 0.5345 mol) and HDDA (7.50 g, i.e. 0.0332 mol) were introduced into the dropping funnel and mixed therein. The mixture is introduced into the reactor dropwise over a period of 1 hour 30 minutes. During the introduction of the 2-HEA+HDDA, the temperature was maintained below 50° C. by controlling the exothermicity with an ice-water bath. After introduction of the 2-HEA+HDDA, the temperature was maintained at 50° C. for 1 hour. Butyl acetate (17.22 g) was then added via the dropping funnel (over 5 minutes), then the temperature was lowered to 30° C. HDI (23.94 g, i.e. 0.1425 mol) was then added dropwise via the dropping funnel over a period of 45 minutes. During the introduction of the HDI, the temperature was maintained below 50° C. by controlling the exothermicity with an ice-water bath. IPDI (10.55 g, i.e. 0.0475 mol) was then added via the dropping funnel over a period of 15 minutes. During the introduction of the IPDI, the temperature was maintained below 50° C. by controlling the exothermicity with an ice-water bath. The temperature was brought to and maintained at 80° C. for 1 hour.

The amine value was then measured at 197 mg KOH/g. Infrared (IR) analysis showed the total consumption of the isocyanate functions initially present.

Example 4: Preparation and evaluation of crosslinkable two-component polyurethane compositions according to the invention

The polyol catalysts of the invention prepared in examples 1, 2 and 3 were tested in varnish compositions based on acrylic resins.

The commercial resins used were the following:
Synocure® 862×60 resin: hydroxylated acrylic resin having an I_{OH} of 1.55% relative to the solid resin with a high viscosity (5500-8000 MPa·s at 25° C.) and a solids content of 60% in xylene.
Synocure® 9293 BA 70 resin: hydroxylated acrylic resin with a high solids content having an I_{OH} of 2.9% relative to the solid resin with a low viscosity (1000-2000 MPa·s at 25° C.) and a solids content of 70% in butyl acetate.
Synocure® 9201 S 75 resin: hydroxylated acrylic resin with a high solids content having an I_{OH} of 4.2% relative to the solid resin with a moderate viscosity (3000-4000 MPa·s at 25° C.) and a solids content of 75% in a mixture of solvents (butyl acetate/ethyl 3-ethoxypropionate).
LP1164 resin: aliphatic polyester polyol resin having an I_{OH} of 4.5% relative to the solid resin with a high viscosity (7500-12 500 MPa·s at 25° C.) and a solids content of 70% in Solvesso™ 100.
Synocure® E21091 resin: hydroxylated acrylic resin with a high solids content having an I_{OH} of 4.1% relative to the solid resin with a moderate viscosity (4000-7500 MPa·s at 25° C.) and a solids content of 75% in butyl acetate.

Formulations made with Synocure 862×60 resin:

| | F | | |
|---|---|---|---|
| Varnish compositions | (comparative) | G | H |
| Synocure ® 862 X 60 | 74.89 | 70.12 | 86.44 |
| Polyol catalyst of example 1 | — | 2.83 | — |
| Polyol catalyst of example 2 | — | — | 3.10 |
| Butyl acetate (BA) | 15.17 | 18.79 | 0 |
| Dibutyltin dilaurate | 2.30 | — | — |
| (DBTDL) (1% in BA) | | | |
| Tolonate ™ HDT-LV2* | 7.64 | 8.26 | 10.46 |
| Total weight of the | 100.00 | 100.00 | 100.00 |
| formulation (g) | | | |
| Solids by volume (%) | 46.5 | 46.5 | 59.6 |
| High-shear viscosity of the | 708 | 605 | Very |
| formulation (mPa · s) | | | viscous |
| (measured using a CAP 1000 | | | |
| viscometer, with a no. 3 | | | |
| spindle, at 25° C.) | | | |
| Pot life | 2 h 35 min | 15 h 50 min | — |
| Dry thickness on QD46 (μm) | 38 | 40 | 54 |
| Persoz hardness on day 1 | 154 | 152 | 132 |
| Persoz hardness on day 7 | 268 | 279 | — |
| Persoz hardness on day 14 | 290 | 296 | — |
| Dry thickness on QD46 (μm) | 38 | 40 | 54 |
| Adhesion test after 1/7/14 | 0/0/0 | 0/0/0 | 0/0/0 |
| days on QD46 | | | |
| Dry thickness on QD46 (μm) | 30 | 38 | 55 |
| Chemical resistance after | 55 | 111 | 120 |
| 7 days (s) | | | |
| Dry thickness on QD46 (μm) | 31 | 41 | 48 |
| Dust-free drying time | <24 min | 36 min | 35 min |

*Tolonate ™ HDT-LV2: solvent-free, low viscosity hexamethylene diisocyanate trimer with an NCO content of 23%, sold by Vencorex.

The addition of polyol catalysts according to the invention to the commercial resin Synocure® 862×60 confers the following properties on the two-component polyurethane system (compared to the reference composition comprising a catalyst based on dibutyltin dilaurate (DBTDL)):
increase in the pot life, which allows a greater period of time for applying the varnish,
a dust-free drying time very close to the reference without a polyol catalyst,
the polyol catalyst of example 1 gives a development of the Persoz hardness which is similar to, or even slightly greater than, the reference without a polyol catalyst. The polyol catalyst of example 2 having, in this test, a thicker coating, leads to a poorer development of the Persoz hardness,
improvement in the chemical resistance to MEK of the systems with polyol catalysts according to the invention, even if the thicknesses differ,
very good adhesion.

Formulations made with Synocure® 9293 BA 70 resin:

| | I | | |
|---|---|---|---|
| Varnish compositions | (comparative) | J | K |
| Synocure ® 9293 BA 70 | 75.81 | 71.56 | 71.33 |
| Polyol catalyst of example 1 | — | 3.32 | — |
| Polyol catalyst of example 2 | — | — | 2.91 |
| Butyl acetate (BA) | 5.11 | 8.30 | 8.76 |
| Dibutyltin dilaurate (DBTDL) | 2.64 | — | — |
| (1% in BA) | | | |
| Tolonate ™ HDT-LV2* | 16.44 | 16.81 | 17.00 |
| Total weight of the | 100.00 | 100.00 | 100.00 |
| formulation (g) | | | |
| Solids by volume (%) | 65.0 | 65.0 | 65.0 |
| High-shear viscosity of the | 647 | 615 | 542 |
| formulation (mPa · s) | | | |
| (measured using a CAP 1000 | | | |
| viscometer, with a no. 3 | | | |
| spindle, at 25° C.) | | | |
| Pot life | 2 h 40 min | 14 h | 6 h 10 min |
| Dry thickness on QD46 (μm) | 50 | 49 | 51 |
| Persoz hardness on day 1 | 113 | 116 | 193 |
| Persoz hardness on day 7 | 294 | 313 | 255 |
| Persoz hardness on day 14 | 312 | 323 | 271 |
| Dry thickness on QD46 (μm) | 50 | 49 | 51 |
| Adhesion test after 1/7/14 | 0/0/0-1 | 0/0/0 | 0/0/0 |
| days on QD46 | | | |
| Dry thickness on QD46 (μm) | 40 | 51 | 52 |
| Chemical resistance after 7 | 84 | 115 | 90 |
| days (s) | | | |
| Dry thickness on QD46 (μm) | 41 | 50 | 54 |
| Dust-free drying time | 35 min | 56 min | 48 min |

*Tolonate ™ HDT-LV2: solvent-free, low viscosity hexamethylene diisocyanate trimer with an NCO content of 23%, sold by Vencorex.

The addition of polyol catalysts according to the invention to the commercial resin Synocure® 9293 BA 70 confers the following properties on the two-component polyurethane system (compared to the reference composition comprising a catalyst based on dibutyltin dilaurate (DBTDL)):
increase in the pot life, which allows a greater period of time for applying the varnish,
a dust-free drying time very close to the reference without a polyol catalyst,
the polyol catalyst of example 1 gives a development of the Persoz hardness which is similar to, or even slightly greater than, the reference without a polyol catalyst. The polyol catalyst of example 2 gives a development of the initial Persoz hardness which is much greater than the reference, and a more moderate development of the Persoz hardness over time,
improvement in the chemical resistance to MEK of the systems with polyol catalysts according to the invention,
very good adhesion.

Formulations made with Synocure® 9201 S 75 resin:

| | L | | |
|---|---|---|---|
| Varnish compositions | (comparative) | N | M |
| Synocure ® 9201 S 75 | 64.49 | 61.19 | 60.97 |
| Polyol catalyst of example 1 | | 3.03 | — |
| Polyol catalyst of example 2 | — | — | 2.68 |
| Butyl acetate (BA) | 11.23 | 13.85 | 14.26 |
| Dibutyltin dilaurate (DBTDL) | 2.42 | — | — |
| (1% in BA) | | | |
| Tolonate ™ HDT-LV2* | 21.86 | 21.93 | 22.09 |
| Total weight of the | 100.00 | 100.00 | 100.00 |
| formulation (g) | | | |
| Solids by volume (%) | 65.0 | 65.0 | 65.0 |
| High-shear viscosity of the | 389 | 355 | 359 |
| formulation (mPa · s) | | | |
| (measured using a CAP 1000 | | | |
| viscometer, with a no. 3 | | | |
| spindle, at 25° C.) | | | |
| Pot life | 1 h 10 min | 9 h | 4 h 40 min |
| Dry thickness on QD46 (μm) | 50 | 49 | 50 |
| Persoz hardness on day 1 | 152 | 65 | 222 |
| Persoz hardness on day 7 | 315 | 337 | 294 |
| Persoz hardness on day 14 | 320 | 347 | 303 |
| Dry thickness on QD46 (μm) | 50 | 49 | 50 |
| Adhesion test after 1/7/14 | 0/0/0 | 0/0/0 | 0/0/0 |
| days on QD46 | | | |
| Dry thickness on QD46 (μm) | 48 | 48 | 50 |
| Chemical resistance after 7 | 90 | 100 | 85 |
| days (s) | | | |
| Dry thickness on QD46 (μm) | 48 | 47 | 51 |
| Dust-free drying time | 2 h 40 min | — | 3 h 10 min |

*Tolonate ™ HDT-LV2: solvent-free, low viscosity hexamethylene diisocyanate trimer with an NCO content of 23%, sold by Vencorex.

The addition of polyol catalysts according to the invention to the commercial resin Synocure® 9201 S 75 confers the following properties on the two-component polyurethane system (compared to the reference composition comprising a catalyst based on dibutyltin dilaurate (DBTDL)):
increase in the pot life, which allows a greater period of time for applying the varnish,
a dust-free drying time for the varnish comprising the polyol catalyst of example 2 which is very close to the reference without a polyol catalyst,
the polyol catalyst of example 1 gives a development of the Persoz hardness which is similar to, or even slightly greater than, the reference without a polyol catalyst. The polyol catalyst of example 2 gives a development of the initial Persoz hardness which is much greater than the reference, with a good development of the Persoz hardness over time,
improvement in the chemical resistance to MEK of the systems with polyol catalysts according to the invention,
very good adhesion.

Formulations made with LP1164 resin:

| | A | B | | | | |
|---|---|---|---|---|---|---|
| Varnish composition | (comp.) | (comp.) | C | | D | E |
| LP1164 | 66.15 | 66.15 | 64.01 | | 62.58 | 60.46 |
| Polyol catalyst of example 3 | — | — | 1.58 | | 2.64 | 4.21 |
| Butyl acetate (BA) | 10.72 | 9.29 | 11.20 | | 11.51 | 11.98 |
| Dibutyltin dilaurate (DBTDL) (1% in BA) | | 1.43 | | | | |
| Tolonate ™ HDT-LV2* | 23.13 | 23.13 | 23.21 | | 23.27 | 23.35 |
| Total weight of the formulation (g) | 100.00 | 100.00 | 100.00 | | 100.00 | 100.00 |
| Solids by volume (%) | 65.0 | 65.0 | 65.0 | | 65.0 | 65.0 |
| High-shear viscosity of the formulation | 622 | 854 | 870 | | 819 | 724 |
| (mPa · s) (measured using a CAP 1000 | | | | | | |
| viscometer, with a no. 3 spindle, at 25° C.) | | | | | | |
| Pot life | 41 min | 34 min | 1 h 15 min | | 56 min | 51 min |
| Dry thickness on QD46 (μm) | 40 | 45 | 38 | 60 | 43 | 65 |
| Persoz hardness on day 1 | 50 | 44 | 110 | 58 | 111 | 24 |
| Persoz hardness on day 7 | 176 | 118 | — | 153 | 158 | 31 |
| Persoz hardness on day 14 | — | | — | 191 | — | 28 |
| Dry thickness on QD46 (μm) | 274 | 170 | — | — | 171 | — |
| Persoz hardness on day 1 | 281 | 168 | 295 | 202 | 165 | 29 |
| Dry thickness on QD46 (μm) | 40 | 45 | 38 | 60 | 43 | 65 |
| Adhesion test after 1/7/14 days on QD46 | 5 | 4-5 | 3-3 | 1-1 | 4-4 | 0-0 |
| Dry thickness on QD46 (μm) | 40 | 45 | 38 | 60 | 43 | 65 |
| Chemical resistance after 7 days (s) | 60 | 60 | 60 | 140 | 55 | 60 |
| Dry thickness on QD46 (μm) | 40 | 45 | — | 60 | 43 | 60 |
| Dust-free drying time | about | about | about | 6 h 15 | about | <3 h |
| | 5 h | 3 h | 3 h | min to 7 | 3 h | 30 min |
| | | | | h 15 min | | |

*Tolonate ™ HDT-LV2: solvent-free, low viscosity hexamethylene diisocyanate trimer with an NCO content of 23%, sold by Vencorex.

The addition of polyol catalysts according to the invention to the commercial resin LP1164 confers the following properties on the two-component polyurethane system (compared to the reference varnish composition B comprising a catalyst based on dibutyltin dilaurate (DBTDL)):
increase in the pot life, which allows a greater period of time for applying the varnish,
a dust-free drying time which is very close to the reference without a polyol catalyst,
the polyol catalyst of example 1 in varnish compositions C and D, at constant thickness, gives a development of the initial Persoz hardness which is much greater than the reference, with a good development of the Persoz hardness over time,
a chemical resistance to MEK of the systems with polyol catalyst according to the invention which is similar to the reference without a polyol catalyst,
improvement in the adhesion, at constant thickness. A small amount of polyol catalyst according to the invention is sufficient to obtain a better adhesion.

### Evaluation of the Accelerated UV Aging:

The polyol catalyst of example 2 was tested under UVB aging with the Synocure® E21091 resin in the following two-component polyurethane systems:
Cromax® 840R epoxy primer/Varnish: the polyol catalyst of example 2 was tested at two different resin/catalyst ratios: 97/3 and 95/5 (Cromax/Varnish 97/3 and Cromax/Varnish 95/5),
Direct To Metal (DTM)/Varnish: the polyol catalyst of example 2 was tested at the resin/catalyst ratio of 95/5 (Varnish DTM 95/5),
Direct to Metal (DTM)/Paint: the polyol catalyst of example 2 was tested at the resin/catalyst ratio of 97/3 (Paint DTM 97/3).

The behavior of these two-component polyurethane systems was compared with the Synocure® E21091 resin comprising dibutyl tin dilaurate (DBTDL) as catalyst at 0.05% by weight relative to the weight of the dry resin (reference) (Cromax/Varnish DBTDL and Paint DTM DBTDL).

Formulations made with Synocure® E21091 resin:

| Varnish and paint | O | | | R | |
|---|---|---|---|---|---|
| compositions | (comp.) | P | Q | (comp.) | S |
| Synocure ® E21091 | 64.02 | 60.51 | 61.62 | 40.67 | 39.32 |
| Poiyol catalyst of | 0 | 2.70 | 1.62 | 0 | 1.03 |
| example 2 | | | | | |
| Butyl acetate (BA) | 12.06 | 15.07 | 15.23 | 3.85 | 5.61 |
| Disperbyk ® 163 | 0 | 0 | 0 | 1.27 | 1.27 |
| Kronos ® 2360 | 0 | 0 | 0 | 31.81 | 31.83 |
| Tolonate ™ HDT-LV2* | 21.48 | 21.73 | 21.53 | 13.65 | 13.74 |
| Dibutyltin dilaurate | 2.44 | 0 | 0 | 1.55 | 0 |
| (DBTDL) (1% in BA) | | | | | |
| Butyl acetate (BA) | 0 | 0 | 0 | 7.20 | 7.20 |
| Total weight of the | 100.00 | 100.01 | 100.00 | 100.00 | 100.00 |
| formulation (g) | | | | | |
| Pigment volume | 0 | 0 | 0 | 17 | 17 |
| concentration (PVC) (%) | | | | | |
| Solids by volume (%) | 65 | 65 | 64.6 | 65 | 65 |
| High-shear viscosity of | 440 | 380 | 385 | 3070 | 2660 |
| the formulation (mPa · s) | | | | | |
| (measured using a CAP | | | | | |
| 1000 viscometer, with a | | | | | |
| no. 3 spindle, at 25° C.) | | | | | |

*Tolonate ™ HDT-LV2: solvent-free, low viscosity hexamethylene diisocyanate trimer with an NCO content of 23%, sold by Vencorex.

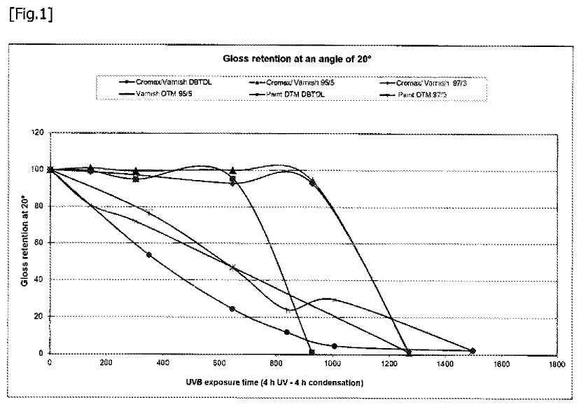

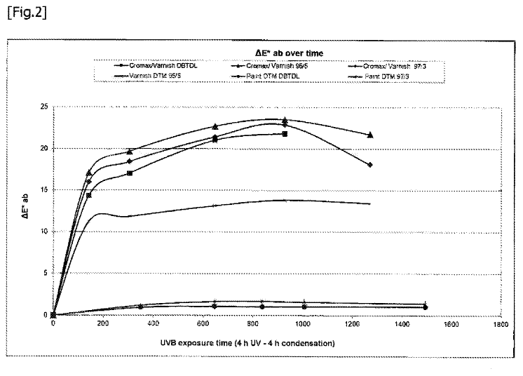

Measurements of gloss at 20° and color (ΔE* ab) over time were carried out. The results are presented in FIGS. 1 and 2.

After 1500 hours of UVB exposure, the following observations were made for gloss measurements at 20° over time (FIG. 1):
In the Cromax® 840R epoxy primer/Varnish system: the Synocure® E21091 resin with the polyol catalyst of the invention has a better (longer) gloss retention than the Synocure® E21091 resin with DBTDL. In particular, the gloss of the Synocure® E21091 resin with the polyol catalyst of the invention maintains very good gloss retention up to about 1000 h of UVB exposure, whereas the gloss of the Synocure® E21091 resin with DBTDL drops after 800 h of exposure.
In the DTM/Paint system: the Synocure® E21091 resin with the polyol catalyst of the invention has a better gloss retention than the Synocure® E21091 resin with DBTDL.
In the DTM/Varnish system: the gloss retention is intermediate and follows the evolution of the Synocure® E21091 resin with the polyol catalyst of the invention in the DTM/Paint system.

After 1500 hours of UVB exposure, the following observations were made for the color measurements (ΔE* ab) over time (FIG. 2):
In the Cromax® 840R epoxy primer/Varnish system: the Synocure® E21091 resin with the polyol catalyst of the invention at a ratio of 97/3 is very similar to the Synocure® E21091 resin with DBTDL. The Synocure® E21091 resin with the polyol catalyst of the invention at a ratio of 95/5 is slightly more colored.
In the DTM/Paint system: the Synocure® E21091 resin with the polyol catalyst of the invention has a color very similar to the Synocure® E21091 resin with DBTDL. The values of ΔE* ab are close to 1 and remain stable. No noticeable difference is observed with the naked eye.
In the DTM/Varnish system: ΔE* ab is intermediate and of the order of 13.

1. A polyol catalyst comprising:
at least two alcohol functions,
at least one catalyst function selected from imidazole functions or tertiary amine functions or both, and
at least one urea function.

2. The catalyst as claimed in claim 1, characterized in that the tertiary amine function has a pKa≥9.

3. The catalyst as claimed in claim 1, characterized in that the tertiary amine function corresponds to the formula —NR₁R₂ wherein R₁ and R₂, which may be identical or different, represent a C1-C4 alkyl or a cycloalkyl or R₁ and R₂ form a C2-C6 heterocycle.

4. The catalyst as claimed in claim 1, characterized in that the imidazole function corresponds to the following formula: 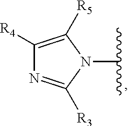
wherein R₃, R₄ and R₅ are independently selected from H, alkyl, aryl and alkylaryl or R₄ and R₅, together with the carbon atoms to which they are bonded, form a ring.

5. The catalyst as claimed in claim 1, characterized in that the urea function is a substituted urea function corresponding to the formula 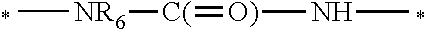
wherein R₆ is other than H, and R₆ originates from a Michael reaction between a primary amine and a compound functionalized with at least one (meth)acrylate group.

6. The catalyst as claimed in claim 1,
characterized in that the urea function corresponds to the formula 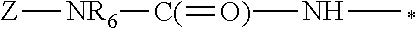
wherein:
R₆ comprises a unit of formula #—CH₂—CH₂—C(═O)—O—§
Z is —A′—(CAT)ₚ wherein:
A′ is an alkylene or an alkylene comprising at least one heteroatom,
p is 1 or 2,
CAT is the catalyst function;
the symbol * represents a point of attachment to a carbon atom,
the symbol # represents a point of attachment to the nitrogen atom of the substituted urea function, and
the symbol § represents a point of attachment to a carbon atom.

7. The catalyst as claimed in claim 1, characterized in that the catalyst corresponds to formula (1): 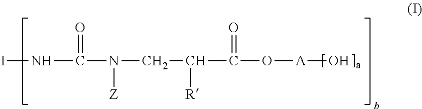
wherein:
I is a residue of a polyisocyanate,
R′ is H or methyl,
Z is a group comprising the at least one-catalyst function,
A is a residue of a polyol,
a=1 to 5, and
b=2 to 3.

8. A process for preparing the catalyst as claimed in claim 1, characterized in that the process comprises the steps:
(i) Michael reaction between a hydroxylated (meth)acrylate monomer and a monomer having at least one primary amine function and at least one catalyst function selected from imidazole functions or tertiary amine functions or both, and
(ii) reaction between an amino-ester compound obtained on conclusion of step (i) with a polyisocyanate.

9. The process as claimed in claim 8, characterized in that the hydroxylated (meth)acrylate monomer used during step (i) is selected from the group consisting of 2-hydroxyethyl acrylate, 2-hydroxypropyl acrylate, 3-hydroxypropyl acrylate, 2-hydroxybutyl acrylate, 3-hydroxybutyl acrylate, 4-hydroxybutyl acrylate, 2-hydroxy-3-phenoxypropyl acrylate, 3-chloro-2-hydroxypropyl acrylate, glycerol monoacrylate, trimethylolpropane monoacrylate, di(trimethylolpropane) monoacrylate, trimethylolethane monoacrylate, pentaerythritol monoacrylate, dipentaerythritol monoacrylate, polyethylene glycol monoacrylate, polypropylene glycol monoacrylate, polyethylene-co-polypropylene glycol acrylate, polytetramethylene glycol monoacrylate, a polycaprolactone (meth)acrylate corresponding to the following formula (2): 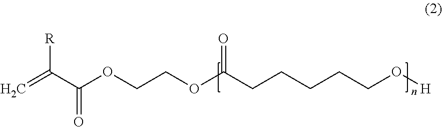
wherein R represents H or methyl, and n=1 to 10,
and mixtures thereof.

10. The process as claimed in claim 8, characterized in that the monomer having at least one primary amine function and at least one catalyst function selected from imidazole functions or tertiary amine functions or both which is used during step (i) is selected from the group consisting of N,N-dimethylethylenediamine, N,N-diethylethylenediamine, dimethylaminopropylamine (DMAPA), 3-(diethylamino)-1-propylamine (DEAPA), 4-(dimethylamino)-1-butylamine, 4-(diethylamino)-1-butylamine, 5-(dimethylamino)-1-pentylamine, N,N-dimethyldipropylenetriamine (DMAPAPA), 2-morpholinoethylamine, 3-morpholinopropylamine, 2-piperidinoethylamine, 3-piperidinopropylamine, 5-piperidinopentylamine, 2-(4-methyl-1-piperidinyl) ethanamine, 2-pyrrolidinoethylamine, 3-pyrrolidinopropylamine, 2-(2-aminoethyl)-1-methylpyrrolidine, 2-(4-methyl-piperazin-1-yl)-ethylamine, 1-(3-aminopropyl) imidazole, 1-(3-aminopropyl)-2-methyl-1H-imidazole, 1-(4-aminobutyl) imidazole, er and mixtures thereof.

11. The process as claimed in claim 8, characterized in that the polyisocyanate used during step (ii) is selected from the group consisting of isophorone diisocyanate (IPDI), toluene diisocyanate (TDI), diphenylmethane-4,4′-diisocyanate (4,4′-MDI), dicyclohexylmethane-4,4′-diisocyanate, tetramethylxylene diisocyanate (TMXDI), hydrogenated tetramethylxylene diisocyanate, hexamethylene diisocyanate (HDI), norborane diisocyanate (NBDI), trimethylenehexamethylene diisocyanate, 1,5-naphthylene diisocyanate, biuret, allophanate and isocyanurate forms of these polyisocyanates, or and mixtures thereof.

12. (canceled)

13. (canceled)

14. A crosslinkable two-component polyurethane composition, characterized in that the crosslinkable two-component polyurethane composition comprises:
a) a polyisocyanate component,
b) a polyol component comprising:
b1) from 0.1% to 100% by weight, relative to the total weight of the polyol component, of the polyol catalyst as claimed in claim 1, and
b2) from 0 to 99.9% by weight, relative to the total weight of the polyol component, of another polyol component free of a catalyst function selected from imidazole functions or tertiary amine functions or both.

15. The composition as claimed in claim 14, wherein the polyol component comprises:
b1) from 0.1% to 100% by weight, relative to the total weight of the polyol component, of the polyol catalyst, and
b2) from 90% to 99.9% by weight, relative to the total weight of the polyol component, of the another polyol component free of a catalyst function selected from imidazole functions or tertiary amine functions or both.

16. The composition as claimed in claim 14, wherein the polyol component comprises:
b1) from 10% to 100% by weight, relative to the total weight of the polyol component, of the polyol catalyst, and
b2) from 0 to 90% by weight, relative to the total weight of the polyol component, of another polyol component free of a catalyst function selected from imidazole functions or tertiary amine functions or both.

17. The composition as claimed in claim 14, characterized in that the composition is free of tin-based catalyst.

18. The composition as claimed in claim 14, characterized in that the composition is a coating composition selected from paint, varnish, ink, adhesive or glue compositions.

19. A process for preparing a coating, characterized in that it comprises a step of applying a crosslinkable two-component polyurethane composition as claimed in claim 14 on a substrate, followed by a step of drying said composition.

20. A substrate coated with a crosslinkable two-component polyurethane composition as claimed in claim 14, characterized in that the substrate is selected from the group consisting of metal, glass, wood, including chipboard and plywood, plastic, metal, concrete, plaster, composite and textile substrates.
